(19) United States
(12) Patent Application Publication
(10) Pub. No.: US 2020/0280143 A1
(43) Pub. Date: Sep. 3, 2020

(54) QUICK CONNECTOR FOR ELECTRIC INSTALLATIONS

(71) Applicant: PARKKISÄHKÖ OY, Helsinki (FI)

(72) Inventors: Peter ANDERSIN, Tenhola (FI); Mika Peter KOSONEN, Kerava (FI)

(21) Appl. No.: 16/650,031

(22) PCT Filed: Sep. 24, 2018
(86) PCT No.: PCT/FI2018/050689

§ 371 Date: Mar. 24, 2020

(30) Foreign Application Priority Data
Sep. 24, 2017 (FI) 20175848

(51) Int. Cl. H01R 9/24; H01R 13/42

(52) U.S. Cl. CPC H01R 9/2491; H01R 4/30; H01R 2201/26; H01R 13/42

(57) ABSTRACT

A quick connector for electric installations comprising a connector frame (1), where when the incoming hole (10) of a male connector fitting into the connector is directed upwards, there is a hole (2) on the bottom surface of the connector frame in order to install an essentially rectangular U-shaped female connector contact strip (3) and a spring (4) into the connector frame (1) so that one end of the U-shaped contact strip together with the spring are arranged to form a contact with the contact of a male connector, and the other end of the U-shaped contact strip is accessible from the frame of the connector for receiving a cable joint device (6) to connect the cable conductor.

The invention relates to the construction and assembly of a quick connector for electric installations.

The object of the invention is to create a multipolar connector that is easier to install and assemble than before and that can be used also at large currents and high voltages, e.g., as part of a system for charging electric vehicles. The invention may be used together with the invention of the prior application PCT/FI2016/050787 of the applicant.

According to one embodiment, the connector according to the invention is used in electrifying parking areas so that the cabling of the parking area is first wired in a chain so that the incoming cable is connected to the connector and the outgoing cable is connected to the next connector. As many connectors are installed in one installation, and the chain may have several connectors, it is important that the installation work is as easy and quick as possible. In addition, it is advantageous if one or more cables of different thickness can be connected easily. The prior art connectors are cumbersome to install when using thick and rigid cables. The object of the invention is to ease the installation of cabling and the quick connectors.

A connector according to the invention is easy to assemble, as only two parts for one connector contact are needed for the connector frame itself that are easy to insert in place, and after that the parts remain in place with the help of friction. Once the connector frame with the contacts has been assembled, it can be slided into the base of the appliance casing along bars or rails, or the connector frame can be attached to the appliance casing in some other way. After that, the connector frame can be locked in place with a separate body, such as a plug, a screw, or a flexible latch. The connector frame may also remain in place held only by the lid of the casing if suitable holes have been shaped in the lid in which the counterparts of the connector frame fit. The live parts of the connector frame installed in place are sufficiently shielded. The connector frame may be installed in the quick connector casing, e.g., in a block heater pole in a parking area, on the wall of a parking garage, or in a mounting rail, and later, e.g., a car heating unit that has time switches can be installed in the connector.

In the most common embodiment, the connector frame itself remains inside the appliance casing. In this case, the appliance casing may be, e.g., an enclosure that is attached to the block heater pole of a parking space, and can be openable from one or two sides. The casing can be installed also onto a wall or stand.

When the cable conductors have been installed in the connector frame, the connector frame needs to be attached to the appliance casing. This may be performed, e.g., by sliding the appliance casing horizontally, in which case the front panel of the appliance casing is openable, through which also the cable ends are installed. It is also possible to slide or attach the appliance casing from below, meaning the enclosure installed in the pole will be slided from below along the pole. Thus, one part of the enclosure has been inserted into the pole before the installation of the wires, and it will be lifted into its position after the installation. For a pole installation of the appliance casing, a supporting member for the connector frame is needed, and the cover of the appliance casing is installed by sliding it from below. The peeled cable conductors can be installed after the connector frame is attached in the appliance casing, before closing the casing.

The appliance casing of the connector may have a cap, that is removable for connecting a male connector. The cap is protecting the connector's contacts against anyone touching the contacts by a conductive object, impact, touching and elements before the male connector is installed. The appliance casing may have a steady metal face with connecting means for attaching a male connector of, for example, a block heating device box or an electric vehicle charging device. This allows easy changinge of hardware in a parking area.

The cables themselves may be attached so that the peeled ends of the cable are first pushed to the space between the insulation walls, and after that a screw press connector is slided around the cable end and the end of the contact strip, and the screw is tightened, causing the ends of the cable or cables to be squeezed against the contact strip. In the example embodiment described here, the screw press connector itself reminds a pillar terminal with the difference that in the embodiment according to the invention the screw connector may be manufactured out of square tube, and the cable and contact strip to be installed in it will be parallel in the finished joint. In addition, the screw press connector may have a body that distributes pressure and acts as a spring either between the screw and the cable or between the back of the cable and the contact strip and the base of the screw press connector.

It is well known that a spring is necessary at least when aluminium cable is used outdoors, in which case the larger coefficient of thermal expansion of aluminium compared to copper alloys or steel causes deformations of the cable and finally the loosening of the joint, unless a flexible member is used for maintaining pressure. A connector according to the invention may also be built using pillar terminals, in which case the requirement for space of the wiring may grow in the vertical direction so that the requirements for insulation and the installation space will be sufficient. Naturally, the cables may be attached using another known method, e.g., by using sleeve connectors or screws.

Characteristic for the invention is what has been described in the characterising part of the independent claims, and the dependent claims describe the embodiments of the invention.

The following describes the invention referring to the drawings.

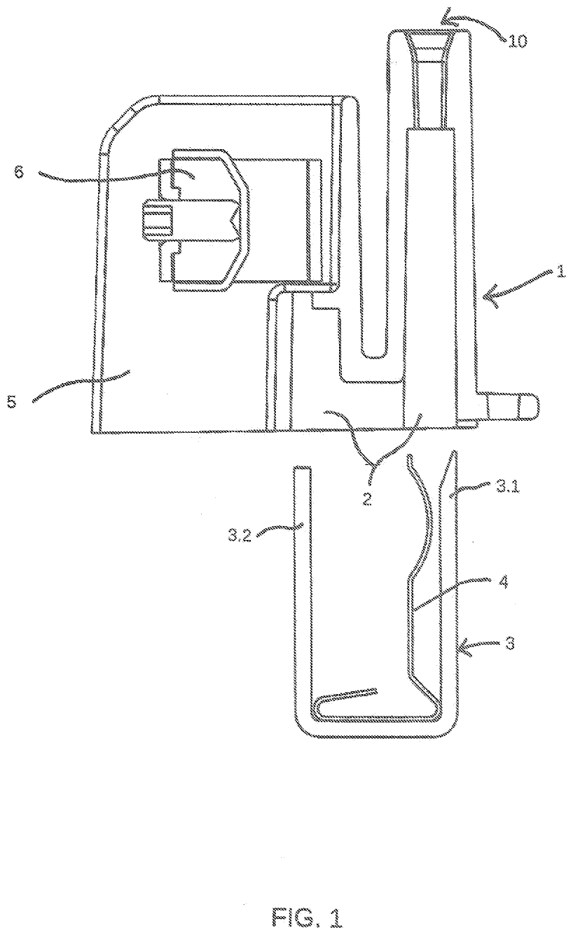

FIG. 1 depicts the cross-section of a connector according to the invention before assembly.

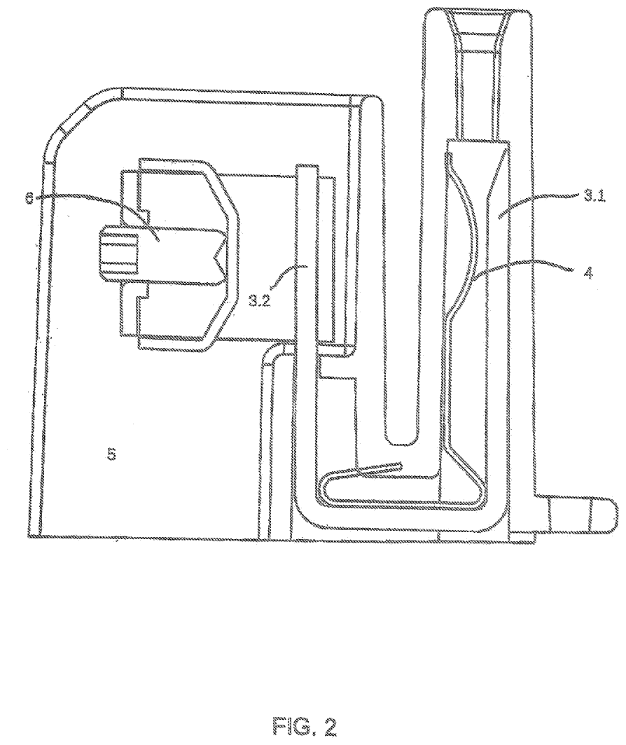

FIG. 2 depicts the parts of the cross-section of FIG. 1 assembled.

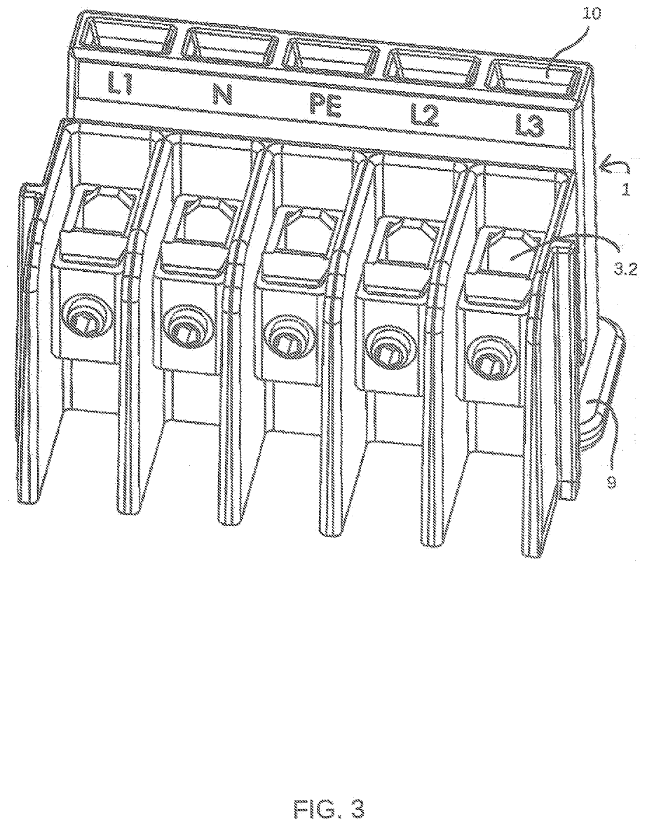

FIG. 3 depicts the assembled connector frame with its screw connectors as a perspective drawing.

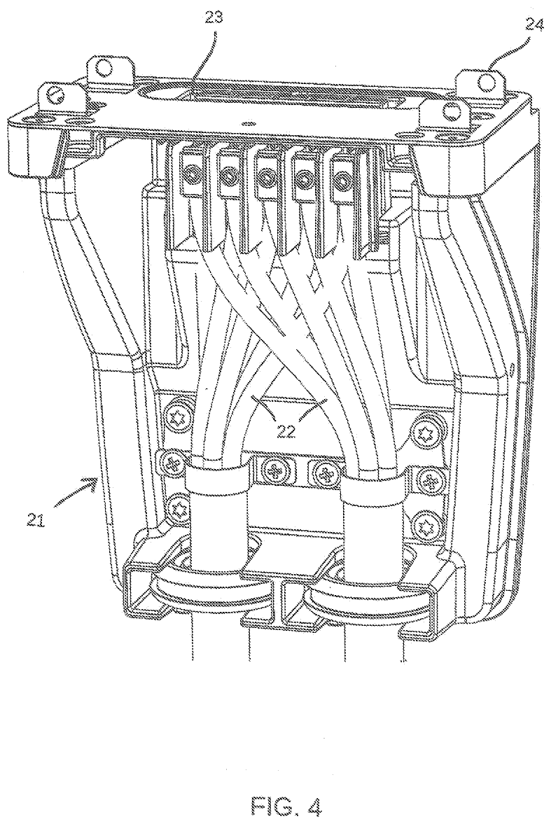

FIG. 4. depicts a wall mount appliance casing with a connector frame and cables installed before closing the casing cover and installing the cap or male connector.

FIG. 1 describes the frame and parts of a connector according to the invention before assembly. By derogation from what is drawn in the figure, the screw press (6) may be loose before installing the cable, which makes the cables easier to install in place, and the screw press connector (6) is inserted only after the cables are in place.

The contact strip (3) is a flat disc-like part bent into a U-shape. It is advantageously bent so that the bending angles differ somewhat from a right angle causing the contact strip to attach to the connector frame with a minor compressive force. With regards to the manufacturing technology, this is also easy to implement, since the strip bent to 90 degrees usually reverts into a slightly more obtuse angle by itself after the bending. The contact end (3.1) of the female connector of the contact strip may be chamfered according to the figure to guide the strip of the male connector. The end (3.2) is attached to the cable, e.g., with a screw press connector (6). The spring (4) squeezes the strip of the male connector tightly to the contact (3.1) of the female connector. The spring also functions to some extent as a body that conveys electrical current. It is to be noted that in FIG. 2 the spring is drawn in a tensionless state by derogation from the reality, causing it to appear to pass within the connector frame. In reality, the spring is naturally squeezed against the contact strip, and it does not go inside the connector frame.

The connector frame may include a metal sleeve insert that is moulded around the female connector's contact area. The sleeve prevents the connector frame from deforming even in high temperatures. The sleeve insert may be inserted in the mould before moulding the plastic or composite connector frame.

The connector frame is made up of suitable dielectric material that withstands the required mechanical and other stress. The connector strips may be made of, e.g., nickled and silvered copper, and the spring may be made of, e.g., bronze or steel. The strips need to be accurate and flat so that the contact surface is large enough. In practice, it is enough that the strip is made flat enough at least with regards to the contact area before bending the strip into a U-shape, or the strips are pressed, faceted, or worked to be flat enough after the bending or before it. The bending somewhat changes the shape of the cross-section of the contact strip, at least close to the location of the bending, but if the angle to be bent is located relatively far from the contact area itself, it usually does not matter.

In FIG. 2, the connector frame is depicted assembled. By derogation from the figure, the screw press connector (6) is usually loose before installing the cable. In addition, the screw connector is described in the figure with the screw screwed in. Naturally, the screw is unscrewed during the installation so that the screw connector can be inserted into place around the cable and the end (3.2.) of the contact strip. A loose or detachable screw press connector makes cable installation easier. The cable may be cut or bent to the right length, peeled, and set in place, after which the screw press connector is inserted around the end of the cable and the contact strip. Thus, inserting the rigid cable into the connector is avoided. According to tests, the savings in work time are significant; in addition, it is easy to install two cables in the same connector to chain the cables, as depicted in FIG. 4. The insulation walls (5) of the connector frame contribute to holding the cables to be installed in place during the installation. The insulation walls make installation easier and create a sufficient insulation gap. The screw press (6) may have a flexible part so that, e.g., the forces produced by the thermal expansion of the cables and the connector remain so small that no permanent transformations or cable joint loosening is created. Instead of a screw press, any cable joint device that can be inserted around the contact strip (3) and the cable can be used. Examples of cable joint devices are at least crimp sleeve, clamp, screw connector, and strong spring loaded clamp.

In FIG. 3, an example of a five-polar connector frame (1) according to the invention is described assembled without cables. The contact strips of the male connector are pushed from the holes (10) into a the contact with female contacts. Around the holes (10), there is a casing that remains inside the protective casing of the male connector when the connectors are attached to one another. The holes (10) around the contacts may come out from the top face cover of the appliance casing so that the cover of the casing has a sufficient gap for the casing of the male connector to slide around the frame of the hole (10). In this context, the terms male connector and female connector describe mostly that the female connector is fixed, and the electrical current is supplied from the female connector described here into the male connector. There is no distinctive difference in the structure of the connectors themselves between the male and female connector. The female connector in this example comprises a contact strip and a spring, and the casing of the female connectortact is actually is in a connected position inside the male connectortact casing.

The contacts or protective earth and neutral may be longer than the contacts of the phases. This causmakes the protective earth to make contact first before the three phases and neutral contacts. The protective earth may be in the middle so that the protective earth connection is easier to verify and more safely making the first contact even when the male connector is pushed in not exactly in right angle.

It is easiest to press the cables into the space between the insulation walls (5) with a proper tool or even with a finger and after that insert the screw press connector in place into a position according to the figure. As the installation cables are quite rigid and thick, it is considerably easier to cut and peel the cables to their correct length and push them laterally in their places and only after that insert the screw connector into its place. Thus, the cable is pushed laterally to the ends (3.2) of the contact strips and the screw press connector is inserted around the cable and the end of the contact strip from the above direction of the figure and the screws are tightened so that the cables are squeezed against the contact strips. In this way, there is no need to bend the cable sharply for the insertion, but it is enough that it is pushed into place and the screw connector is inserted around the cable.

FIG. 4 depicts a connector frame (1) installed in the appliance casing (21). After installing the contact strips, the connector frame itself may be pushed to the frame of the appliance casing with the help of bars (9). The cables (22) may be installed after that. The connector or the appliance casing may include data storage means for storing the configuration information of the charging device that may be connected to the connector. This embodiment is already published in PCT/FI2016/050787.

The appliance casing ((21) may include a top plate with means (24) for securing the charging device. The connector hole (10) is surrounded in FIG. 4 with a hole (23) for inserting the make connector frame.

1. A quick connector for electric installations comprising a connector frame (1), where when the incoming hole (10) of a male connector fitting into the connector is directed upwards, there is a hole (2) on the bottom surface of the connector frame in order to install an essentially rectangular U-shaped female connector contact strip (3) and a spring (4) into the connector frame (1) so that one end of the U-shaped contact strip together with the spring are arranged to form a contact with the contact of a male connector, and the other end of the U-shaped contact strip is accessible from the frame of the connector for receiving a cable joint device (6) to connect the cable conductor.

2. A female connector according to claim 1 comprising several female connector strips (3) of claim 1 side by side in their own holes (2), and on the sides of each of the outcoming end there is a wall (5) of dielectric material that insulates the adjacent connectors from one another and the peeled cable ends may be pressed between the dielectric walls to be attached towards the connector contact strip and then electrically connected to the strip by a cable joint device (6) by inserting the cable joint device (6) around the cable and the contact strip (3) and securing the cable to the contact strip (3).

3. A female connector according to claim 2 where the cable joint device is a screw press connector device having a square profile shape.

4. A female connector according to claim 2, where the cable joint device is one of: a wedge, a clamp, a crimp sleeve, or a strong spring press.

5. A female connector according to claim 2 comprising further means (24) for securing an electric vehicle charging device or a block heater power socket device to the appliance casing (21) of the connector.

6. A connector according to one of the preceding claims that also has data transmission communications means for the device to be attached to it and memory for recording the installation information needed by the charging device.
